(19) United States
(12) Patent Application Publication
(10) Pub. No.: US 2024/0427292 A1
(43) Pub. Date: Dec. 26, 2024

(54) Watch Component And Watch

(71) Applicant: SEIKO EPSON CORPORATION, Tokyo (JP)

(72) Inventor: Tsubasa FUJI, Shiojiri (JP)

(21) Appl. No.: 18/750,106

(22) Filed: Jun. 21, 2024

(30) Foreign Application Priority Data
Jun. 22, 2023 (JP) 2023-102378

(51) Int. Cl. G04B 19/12

(52) U.S. Cl. CPC G04B 19/12

(57) ABSTRACT

A watch component includes a base material and a multilayer film covering at least a portion of the base material, wherein the multilayer film includes a color-adjusting film that is composed of an oxide layer or a fluoride layer and that is formed by dry plating, and the color-adjusting film includes a first color-adjusting film having a refractive index of 2.0 or more, a second color-adjusting film having a refractive index of 1.5 or more and less than 2.0, and a third color-adjusting film having a refractive index of less than 1.5.

The present application is based on, and claims priority from JP Application Serial Number 2023-102378, filed Jun. 22, 2023, the disclosure of which is hereby incorporated by reference herein in its entirety.

### BACKGROUND

### 1. Technical Field

The present disclosure relates to a watch component and a watch.

### 2. Related Art

JP-A-2018-124267 discloses a watch component in which a toning film for adjusting a color tone is stacked on a base plate serving as a metallic luster portion.

Regarding the watch component in JP-A-2018-124267, excellent aesthetics can be ensured by adjusting a color tone of the appearance with the metallic luster portion and the toning film without using a noble metal as a main material.

JP-A-2018-124267 can provide noble-metal-like aesthetics, but there is a problem that it is difficult to express a high-chroma color tone.

### SUMMARY

According to an aspect of the present disclosure, a watch component includes a base material and a multilayer film covering at least a portion of the base material, wherein the multilayer film includes a color-adjusting film that is composed of an oxide layer or a fluoride layer and that is formed by dry plating, and the color-adjusting film includes a first color-adjusting film having a refractive index of 2.0 or more, a second color-adjusting film having a refractive index of 1.5 or more and less than 2.0, and a third color-adjusting film having a refractive index of less than 1.5.

According to an aspect of the present disclosure, a watch includes the above-described watch component.

### BRIEF DESCRIPTION OF THE DRAWINGS

FIG. 1 is a front view illustrating a watch according to an embodiment.

FIG. 2 is a sectional view illustrating a main portion of a dial according to the embodiment.

### DESCRIPTION OF EMBODIMENTS

### Embodiment

A watch 1 according to an embodiment of the present disclosure will be described below with reference to the drawings.

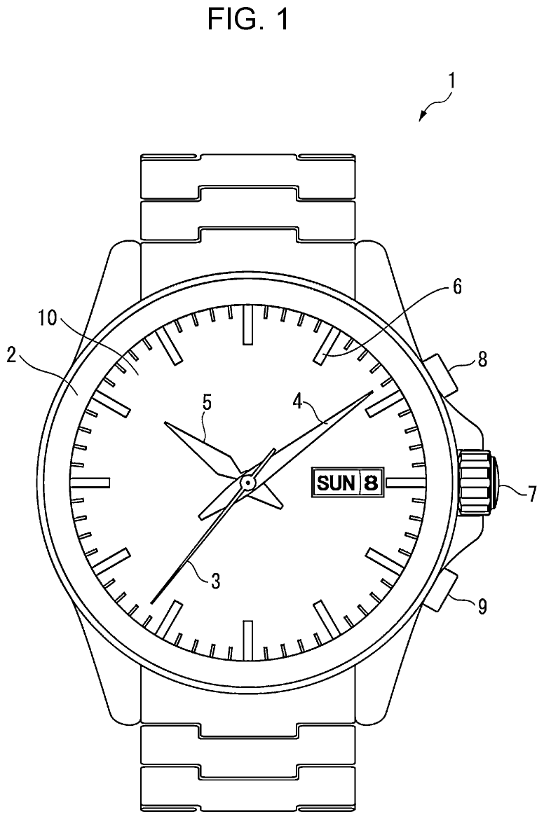

FIG. 1 is a front view illustrating the watch 1. In the present embodiment, the watch 1 is configured to be a wristwatch that is put on a wrist of a user.

As illustrated in FIG. 1, the watch 1 includes a metal case 2. In addition, a disc-like dial 10, a seconds hand 3, a minute hand 4, an hour hand 5, a crown 7, an A button 8, and a B button 9 are included in the interior of the case 2. In this regard, the dial 10 is an example of the watch component according to the present disclosure.

The dial 10 is provided with hour marks 6 to indicate a time.

### Dial

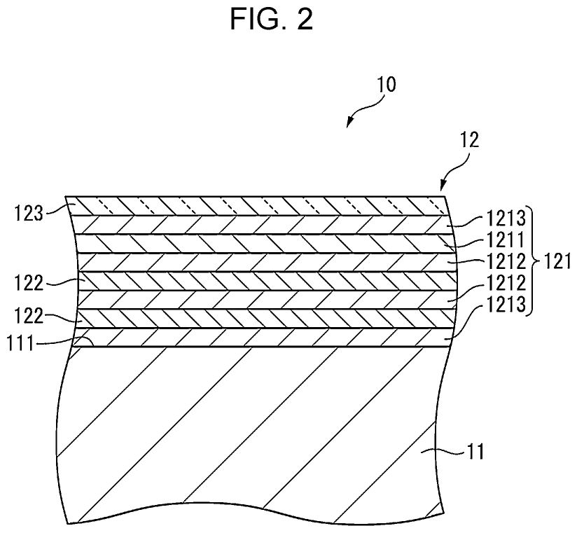

FIG. 2 is a sectional view illustrating a main portion of the dial 10.

As illustrated in FIG. 2, the dial 10 includes a base material 11 and a multilayer film 12.

In the present embodiment, the base material 11 is entirely covered with the multilayer film 12. In this regard, the dial 10 is not limited to the above-described configuration. For example, the multilayer film 12 may be stacked so as to cover a portion of the surface 111 of the base material 11.

### Base Material

A material for forming the base material 11 is composed of, for example, a metal, such as iron, brass, or aluminum, or a resin. In this regard, when the base material 11 is composed of a resin, the resin may be a nontransparent resin that does not pass light or a transparent resin that passes light.

### Multilayer Film

The multilayer film 12 is configured to include a color-adjusting film 121, a color-absorbing film 122, and a protective film 123 and is stacked on the surface 111 of the base material 11.

### Color-Adjusting Film

The color-adjusting film 121 is a film for adjusting a color tone due to optical interference. In the present embodiment, the color-adjusting film 121 is composed of an oxide layer or a fluoride layer and is formed by dry plating. In addition, the color-adjusting film 121 includes a first color-adjusting film 1211, a second color-adjusting film 1212, and a third color-adjusting film 1213.

The first color-adjusting film 1211 is composed of a material containing at least one selected from the group consisting of Ta₂O₅, TiO, TiO₂, TiO₃, Ti₂O₃, Ti₂O₅, Ti₃O₅, ZrO₂, and Nb₂O₅ and is formed so as to have a refractive index of 2.0 or more. Accordingly, the range of the color tone that can be expressed by the base material 11 can be further broadened, and since these inorganic materials have high chemical stability, the stability of the appearance and the durability of the base material 11 can be increased.

In this regard, in the present disclosure, the refractive index is denoted as a value obtained by dividing a propagation rate of light in a vacuum by a propagation rate of light in a substance.

In addition, in the present embodiment, it is preferable that the first color-adjusting film 1211 be formed so as to have a thickness of 50 nm or more. According to such a configuration, colors of a broad hue, such as green, yellow, and red, can be readily expressed.

In this regard, in the multilayer film 12, only one layer of first color-adjusting film 1211 may be formed, or a plurality of first color-adjusting films 1211 may be formed.

The second color-adjusting film 1212 is composed of a material containing at least one selected from the group consisting of SiO, Al₂O₃, MgO, SnO₂, YF₃, LaF₃, CeF₃, and NdF₃ and is formed so as to have a refractive index of 1.5 or more and less than 2.0. Accordingly, the range of the color tone that can be expressed by the base material 11 can be further broadened, and since these inorganic materials have high chemical stability, the stability of the appearance and the durability of the base material 11 can be increased.

In addition, in the present embodiment, the second color-adjusting film 1212 is preferably formed so as to have a thickness of preferably 100 nm or more and more preferably formed so as to have a thickness of 200 nm or more.

In this regard, in the multilayer film 12, only one layer of second color-adjusting film 1212 may be formed, or a plurality of second color-adjusting films 1212 may be formed. When a plurality of second color-adjusting films 1212 are formed, at least one layer thereof may be formed so as to have a thickness of 200 nm or more. Further, one layer of the plurality of second color-adjusting films 1212 may be formed so as to have a larger thickness than a layer constituting the first color-adjusting film 1211 and the third color-adjusting film 1213.

The third color-adjusting film 1213 is composed of a material containing at least one selected from the group consisting of SiO₂, AlF₃, MgF₂, and BaF₂ and is formed so as to have a refractive index of less than 1.5. Accordingly, the range of the color tone that can be expressed by the base material 11 can be further broadened, and since these inorganic materials have high chemical stability, the stability of the appearance and the durability of the base material 11 can be increased.

In addition, in the present embodiment, it is preferable that the third color-adjusting film 1213 be formed so as to have a thickness of 50 nm or more. According to such a configuration, colors of a broad hue, such as green, yellow, and red, can be readily expressed.

In this regard, in the multilayer film 12, only one layer of third color-adjusting film 1213 may be formed, or a plurality of third color-adjusting films 1213 may be formed.

### Color-Absorbing Film

The color-absorbing film 122 is composed of a metal and is formed by dry plating. More specifically, the color-absorbing film 122 is composed of a material containing at least one selected from the group consisting of Ag, Pt, Au, Al, Cr, Ni, Sn, Fe, and Ti. Accordingly, the dial 10 having high aesthetics can be provided. In this regard, in the multilayer film 12, only one layer of color-absorbing film 122 may be formed, or a plurality of color-absorbing films 122 may be formed. Further, in the present embodiment, the multilayer film 12 is formed so that the total number of layers of the color-adjusting film 121 and the color-absorbing film 122 is less than 10.

### Protective Film

The protective film 123 is a transparent layer stacked on the surface side of the multilayer film 12. In the present embodiment, the protective film 123 is formed of a transparent resin such as acryl.

Next, Examples of the present disclosure will be described.

### Example 1

In Example 1, a multilayer film presented in Table 1 was formed on the surface of a base material by dry plating.

As presented in Table 1, in Example 1, one layer of first color-adjusting film having a refractive index of 2.20 was formed of Nb₂O₅. In addition, two layers of second color-adjusting film having a refractive index of 1.64 were formed of Al₂O₃. Further, two layers of third color-adjusting film having a refractive index of 1.47 were formed of SiO₂. In such an instance, the second color-adjusting film constituting the third layer was formed so as to have a thickness of 207.6 nm. In this regard, the second color-adjusting film constituting the third layer was formed so as to have the largest thickness of the layers constituting the multilayer film.

As a result, regarding a dial in Example 1, the hue was red, the brightness L* was 37, the chroma C* was 53, and the hue angle h* was 13. That is, it was indicated that the dial having a hue of red, brightness L* of 30 or more, and chroma C* of 50 or more can be obtained according to the configuration of the multilayer film in Example 1. Consequently, in Example 1 in which the thickness of the second color-adjusting film constituting the third layer was set to be 200 nm or more, the chroma C* of the dial was 50 or more, and it was indicated that the dial having very high chroma can be obtained. Further, in Example 1, the total number of layers of the color-adjusting film and the color-absorbing film was 7, and it was indicated that high chroma can be realized with a small number of layers of less than 10.

In this regard, in the present disclosure, the brightness L* is a value of brightness in the L*a*b* color space specified by CIE (Commission Internationale d'Eclairage). The value of L* of “0” is the brightness of a substance that does not reflect light at all (completely absorb light), and the value of L* of “100” expresses the value of brightness of white that completely reflects light. In addition, the chroma C* is an indicator of the vividness of a color and is represented by a distance between a point expressed by a* and b* and the origin corresponding to an achromatic color.

$${C}^{*} = \sqrt{{( {a}^{*} )}^{2} + {( {b}^{*} )}^{2}} \qquad Formula ( 1 )$$

TABLE 1

| | | | Thickness | Refractive |
|---|---|---|---|---|
| | Type of layer | Material | (nm) | index |
| Eighth layer | Protective layer | epoxy resin | — | 1.60 |
| Seventh layer | Third | SiO₂ | 114.4 | 1.47 |
| | color-adjusting | | | |
| | film | | | |
| Sixth layer | First | Nb₂O₅ | 78.8 | 2.20 |
| | color-adjusting | | | |
| | film | | | |
| Fifth layer | Second | Al₂O₃ | 111.4 | 1.64 |
| | color-adjusting | | | |
| | film | | | |
| Fourth layer | color-absorbing | Cr | 7.3 | 2.70 |
| | film | | | |
| Third layer | Second | Al₂O₃ | 207.6 | 1.64 |
| | color-adjusting | | | |
| | film | | | |
| Second layer | color-absorbing | Cr | 68.4 | 3.10 |
| | film | | | |
| First layer | Third | SiO₂ | 100 | 1.47 |
| | color-adjusting | | | |
| | film | | | |

| | |
|---|---|
| Total thickness | 687.9 |

### Example 2

In Example 2, a multilayer film presented in Table 2 was formed on the surface of a base material by dry plating.

As presented in Table 2, in Example 2, one layer of first color-adjusting film having a refractive index of 2.20 was formed of Nb₂O₅. In addition, two layers of second color-adjusting film having a refractive index of 1.64 were formed of Al₂O₃. Further, one layer of third color-adjusting film having a refractive index of 1.47 was formed of SiO₂. In such an instance, the second color-adjusting film constituting the fourth layer was formed so as to have a thickness of 117.8 nm. In this regard, in Example 2, the third color-adjusting film constituting the sixth layer was formed so as to have the largest thickness of the layers constituting the multilayer film.

As a result, regarding a dial in Example 2, the hue was violet, the brightness L* was 31, the chroma C* was 38, and the hue angle h* was −45. That is, it was indicated that the dial having a hue of violet, brightness L* of 30 or more, and chroma C* of 30 or more can be obtained according to the configuration of the multilayer film in Example 2. Consequently, in Example 2 in which the thickness of the second color-adjusting film constituting the fourth layer was set to be 100 nm or more, the chroma C* of the dial was 30 or more, and it was indicated that the dial having very high chroma can be obtained. Further, in Example 2, the total number of layers of the color-adjusting film and the color-absorbing film was 6, and it was indicated that high chroma can be realized with a small number of layers of less than 10.

TABLE 2

| | | | Thickness | Refractive |
|---|---|---|---|---|
| | Type of layer | Material | (nm) | index |
| Seventh layer | Protective layer | epoxy resin | — | 1.60 |
| Sixth layer | Third | SiO₂ | 146.1 | 1.47 |
| | color-adjusting | | | |
| | film | | | |
| Fifth layer | First | Nb₂O₅ | 93.7 | 2.20 |
| | color-adjusting | | | |
| | film | | | |
| Fourth layer | Second | Al₂O₃ | 117.8 | 1.64 |
| | color-adjusting | | | |
| | film | | | |
| Third layer | color-absorbing | Cr | 12.7 | 2.70 |
| | film | | | |
| Second layer | Second | Al₂O₃ | 88.8 | 1.64 |
| | color-adjusting | | | |
| | film | | | |
| First layer | color-absorbing | Cr | 71.2 | 3.10 |
| | film | | | |

| | |
|---|---|
| Total thickness | 530.3 |

### Example 3

In Example 3, a multilayer film presented in Table 3 was formed on the surface of a base material by dry plating.

As presented in Table 3, in Example 3, one layer of first color-adjusting film having a refractive index of 2.35 was formed of TiO₂. In addition, three layers of second color-adjusting film having a refractive index of 1.64 were formed of Al₂O₃. Further, one layer of third color-adjusting film having a refractive index of 1.47 was formed of SiO₂. In such an instance, the second color-adjusting film constituting the sixth layer was formed so as to have a thickness of 168.8 nm. In this regard, the second color-adjusting film constituting the sixth layer was formed so as to have the largest thickness of the layers constituting the multilayer film.

As a result, regarding a dial in Example 3, the hue was green, the brightness L* was 88, the chroma C* was 45, and the hue angle h* was 102. That is, it was indicated that, the dial having a hue of green, brightness L* of 80 or more, and chroma C* of 40 or more can be obtained according to the configuration of the multilayer film in Example 3. Consequently, in Example 3 in which the thickness of the second color-adjusting film constituting the sixth layer was set to be 150 nm or more, the chroma C* of the dial was 40 or more, and it was indicated that the dial having very high chroma can be obtained. Further, in Example 3, the total number of layers of the color-adjusting film and the color-absorbing film was 7, and it was indicated that high chroma can be realized with a small number of layers of less than 10.

TABLE 3

| | | | Thickness | Refractive |
|---|---|---|---|---|
| | Type of layer | Material | (nm) | index |
| Eighth layer | Protective layer | epoxy resin | — | 1.60 |
| Seventh layer | Third | SiO₂ | 95.3 | 1.47 |
| | color-adjusting | | | |
| | film | | | |
| Sixth layer | Second | Al₂O₃ | 168.8 | 1.64 |
| | color-adjusting | | | |
| | film | | | |
| Fifth layer | First | TiO₂ | 62.0 | 2.35 |
| | color-adjusting | | | |
| | film | | | |
| Fourth layer | Second | Al₂O₃ | 94.9 | 1.64 |
| | color-adjusting | | | |
| | film | | | |
| Third layer | color-absorbing | Cr | 8.4 | 2.70 |
| | film | | | |
| Second layer | Second | Al₂O₃ | 85.1 | 1.64 |
| | color-adjusting | | | |
| | film | | | |
| First layer | color-absorbing | Cr | 68.3 | 3.10 |
| | film | | | |

| | |
|---|---|
| Total thickness | 582.8 |

### Example 4

In Example 4, a multilayer film presented in Table 4 was formed on the surface of a base material by dry plating.

As presented in Table 4, in Example 4, two layers of first color-adjusting film having a refractive index of 2.20 were formed of Nb₂O₅. In addition, one layer of second color-adjusting film having a refractive index of 1.64 was formed of Al₂O₃. Further, one layer of third color-adjusting film having a refractive index of 1.47 was formed of SiO₂. In such an instance, the second color-adjusting film constituting the fourth layer was formed so as to have a thickness of 195.2 nm. In this regard, the second color-adjusting film constituting the fourth layer was formed so as to have the largest thickness of the layers constituting the multilayer film.

As a result, regarding a dial in Example 4, the hue was indigo, the brightness L* was 28, the chroma C* was 42, and the hue angle h* was −88. That is, it was indicated that, the dial having a hue of indigo, brightness L* of 25 or more, and chroma C* of 40 or more can be obtained according to the configuration of the multilayer film in Example 4. Consequently, in Example 4 in which the thickness of the second color-adjusting film constituting the fourth layer was set to be 150 nm or more, the chroma C* of the dial was 40 or more, and it was indicated that the dial having very high chroma can be obtained. Further, in Example 4, the total number of layers of the color-adjusting film and the color-absorbing film was 6, and it was indicated that high chroma can be realized with a small number of layers of less than 10.

TABLE 4

| | | | Thickness | Refractive |
|---|---|---|---|---|
| | Type of layer | Material | (nm) | index |
| Seventh layer | Protective layer | epoxy resin | — | 1.60 |
| Sixth layer | Third | SiO₂ | 88.6 | 1.47 |
| | color-adjusting | | | |
| | film | | | |
| Fifth layer | First | Nb₂O₅ | 23.1 | 2.20 |
| | color-adjusting | | | |
| | film | | | |
| Fourth layer | Second | Al₂O₃ | 195.2 | 1.64 |
| | color-adjusting | | | |
| | film | | | |
| Third layer | color-absorbing | Cr | 9.1 | 2.70 |
| | film | | | |
| Second layer | First | Nb₂O₅ | 54.6 | 2.20 |
| | color-adjusting | | | |
| | film | | | |
| First layer | color-absorbing | Cr | 63.3 | 3.10 |
| | film | | | |

| | |
|---|---|
| Total thickness | 433.8 |

### Modified Example

In this regard, the present disclosure is not limited to the above-described embodiment, and modifications, improvements, and the like within a range in which the purpose of the present disclosure can be achieved are included in the present disclosure.

In the above-described embodiment, the protective film 123 is stacked on the surface side of the multilayer film 12, but the protective film is not limited to this. The present disclosure also includes an instance in which no protective film is stacked on the surface side of the multilayer film.

In the above-described embodiment, the watch component according to the present disclosure is configured to serve as the dial 10, but the watch component is not limited to this. For example, the watch component according to the present disclosure may be configured to serve as any one of a case, a band, a dial ring, a bezel, a movement, a hand, an abbreviation, a moon phase disk, and a moon phase wheel.

### Outline of the Present Disclosure

A watch component according to the present disclosure includes a base material and a multilayer film covering at least a portion of the base material, wherein the multilayer film includes a color-adjusting film that is composed of an oxide layer or a fluoride layer and that is formed by dry plating, and the color-adjusting film includes a first color-adjusting film having a refractive index of 2.0 or more, a second color-adjusting film having a refractive index of 1.5 or more and less than 2.0, and a third color-adjusting film having a refractive index of less than 1.5.

In the present disclosure, the color-adjusting film formed by dry plating includes a first color-adjusting film having a refractive index of 2.0 or more, a second color-adjusting film having a refractive index of 1.5 or more and less than 2.0, and a third color-adjusting film having a refractive index of less than 1.5. Accordingly, a watch component capable of expressing a high-chroma color tone can be provided.

In the watch component according to the present disclosure, the second color-adjusting film may have a thickness of 100 nm or more that is larger than a thickness of the first color-adjusting film and a thickness of the third color-adjusting film.

Accordingly, a high-chroma watch component having a chroma C* of 30 or more can be provided.

In the watch component according to the present disclosure, the second color-adjusting film may have a thickness of 200 nm or more.

Accordingly, a higher-chroma watch component having a chroma C* of 50 or more can be provided.

In the watch component according to the present disclosure, the first color-adjusting film and the third color-adjusting film may have a thickness of 50 nm or more.

Accordingly, colors of a broad hue, such as green, yellow, and red, can be readily expressed.

In the watch component according to the present disclosure, the first color-adjusting film may be composed of a material containing at least one selected from the group consisting of Ta₂O₅, TiO, TiO₂, TiO₃, Ti₂O₃, Ti₂O₅, Ti₃O₅, ZrO₂, and Nb₂O₅.

Accordingly, the range of the color tone that can be expressed by the base material can be further broadened. Further, since these inorganic materials have high chemical stability, the stability of the appearance and the durability of the base material can be increased.

In the watch component according to the present disclosure, the second color-adjusting film may be composed of a material containing at least one selected from the group consisting of SiO, Al₂O₃, MgO, SnO₂, YF₃, LaF₃, CeF₃, and NdF₃.

Accordingly, the range of the color tone that can be expressed by the base material can be further broadened. Further, since these inorganic materials have high chemical stability, the stability of the appearance and the durability of the base material can be increased.

In the watch component according to the present disclosure, the third color-adjusting film may be composed of a material containing at least one selected from the group consisting of SiO₂, AlF₃, MgF₂, and BaF₂.

Accordingly, the range of the color tone that can be expressed by the base material can be further broadened. Further, since these inorganic materials have high chemical stability, the stability of the appearance and the durability of the base material can be increased.

In the watch component according to the present disclosure, the multilayer film may include a color-absorbing film composed of a metal layer, and the total number of layers of the color-adjusting film and the color-absorbing film may be less than 10.

Accordingly, high chroma can be realized with a small number of layers of less than 10.

In the watch component according to the present disclosure, the color-absorbing film may be composed of a material containing at least one selected from the group consisting of Ag, Pt, Au, Al, Cr, Ni, Sn, Fe, and Ti.

Accordingly, since the color-absorbing film is composed of a metal, the watch component having high aesthetics can be provided.

A watch according to the present disclosure includes the above-described watch component.

What is claimed is:

1. A watch component comprising:
a base material; and
a multilayer film covering at least a portion of the base material, wherein
the multilayer film includes a color-adjusting film that is composed of an oxide layer or a fluoride layer and that is formed by dry plating, and
the color-adjusting film includes
a first color-adjusting film having a refractive index of 2.0 or more,
a second color-adjusting film having a refractive index of 1.5 or more and less than 2.0, and
a third color-adjusting film having a refractive index of less than 1.5.

2. The watch component according to claim 1, wherein
the second color-adjusting film has a thickness of 100 nm or more that is larger than a thickness of the first color-adjusting film and a thickness of the third color-adjusting film.

3. The watch component according to claim 2, wherein
the second color-adjusting film has a thickness of 200 nm or more.

4. The watch component according to claim 1, wherein
the first color-adjusting film and the third color-adjusting film have a thickness of 50 nm or more.

5. The watch component according to claim 1, wherein
the first color-adjusting film is composed of a material containing at least one selected from the group consisting of Ta₂O₅, TiO, TiO₂, TiO₃, Ti₂O₃, Ti₂O₅, Ti₃O₅, ZrO₂, and Nb₂O₅.

6. The watch component according to claim 1, wherein
the second color-adjusting film is composed of a material containing at least one selected from the group consisting of SiO, Al₂O₃, MgO, SnO₂, YF₃, LaF₃, CeF₃, and NdF₃.

7. The watch component according to claim 1, wherein
the third color-adjusting film is composed of a material containing at least one selected from the group consisting of SiO₂, AlF₃, MgF₂, and BaF₂.

8. The watch component according to claim 1, wherein
the multilayer film includes a color-absorbing film composed of a metal layer, and
the total number of layers of the color-adjusting film and the color-absorbing film is less than 10.

9. The watch component according to claim 8, wherein
the color-absorbing film is composed of a material containing at least one selected from the group consisting of Ag, Pt, Au, Al, Cr, Ni, Sn, Fe, and Ti.

10. A watch comprising the watch component according to claim 1.
